(19) United States
(12) Patent Application Publication
(10) Pub. No.: US 2022/0237250 A1
(43) Pub. Date: Jul. 28, 2022

(54) SMART DIRECTORY SEARCH

(71) Applicant: Citrix Systems, Inc., Fort Lauderdale, FL (US)

(72) Inventors: Himanshu Parihar, Pompano Beach, FL (US); Krishit Vimal Shah, Pompano Beach, FL (US); Richard John DeFilippo, Coral Springs, FL (US); Ullas Shamasundar, Pompano Beach, FL (US)

(21) Appl. No.: 17/155,302

(22) Filed: Jan. 22, 2021

(51) Int. Cl. G06F 16/9538; G06F 16/901; G06F 16/9535

(52) U.S. Cl. CPC G06F 16/9538; G06F 16/9024; G06F 16/9535; G06F 16/9027

(57) ABSTRACT

A system and method for implementing a smart directory search. A method is disclosed that includes inputting into a sort engine a set user names from a search and organization details of a searching user that includes an organization to which the user belongs; obtaining a policy from a policy store based on the organization and platform, wherein the policy specifies a sort criteria; and applying the sort criteria to the set of user names to generate a sorted list of user names, wherein the sort criteria includes calculating an organizational distance between the user and each of the set of user names.

### BACKGROUND OF THE DISCLOSURE

A benefit of collaboration platforms such as Outlook, Confluence, Jira, BitBucket, etc., is that they enable communication and interaction among virtual members or users. Such platforms typically include search directories that allow a user to enter one or more characters to search for another user, e.g., by name, email address, user id, etc. Such search directories typically re-filter search results each time a new character is entered by the user. In an enterprise with many users, a one or two character search string can generate a large set of search results, requiring the user to scroll down or enter more characters.

### BRIEF DESCRIPTION OF THE DISCLOSURE

Aspects of this disclosure include a system and method that provides a smart directory search that will sort directory search results to return the most relevant results at the top of the list.

A first aspect of the disclosure provides a system that includes a memory and a processor coupled to the memory and configured to implement a collaborative platform having a search facility that returns a set of search results in response to at least one character entered by a user. The platform further includes a sort engine that sorts the set of search results according to method that includes: inputting the set of search results and organization details of the user that include an organization to which the user belongs; obtaining a policy from a policy store based on the organization and the platform, wherein the policy specifies a sort criteria; and applying the sort criteria to the search results to generate a sorted list of search results, wherein the sort criteria includes calculating an organizational distance between the user and each of the search results.

A second aspect of the disclosure provides a method for sorting a set of user names generated by a search facility within a collaborative platform generated in response to at least one character entered by a user. The method includes: inputting into a sort engine the set user names and organization details of the user that includes an organization to which the user belongs; obtaining a policy from a policy store based on the organization and platform, wherein the policy specifies a sort criteria; and applying the sort criteria to the set of user names to generate a sorted list of user names, wherein the sort criteria includes calculating an organizational distance between the user and each of the set of user names.

A third aspect of the disclosure provides a system that includes a memory and a processor coupled to the memory and configured to implement a virtual workspace. The workspace includes a plurality of workspace applications, each having a search facility that performs a search in response to at least one character entered by a user. The workspace also includes a brokering service configured to perform a method that includes: intercepting calls to a search facility within an active application; obtaining a set of search results from the search facility; and determining interaction details of the user with the active application. Also included in the workspace is a first microservice that sorts the set of search according to method that includes: inputting the search results, an organization to which the user belongs and interaction details of the user; obtaining a policy from a second microservice based on the organization and active application, wherein the policy specifies a sort criteria; and applying the sort criteria to the search results to generate a sorted list of search results, wherein the sort criteria includes analyzing the interaction details to calculate a distance between the user and each of the search results.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an illustrative collaboration platform configured to provide smart directory searching, in accordance with an illustrative embodiment.

FIG. 2 depicts a sort policy in accordance with an illustrative embodiment.

FIG. 3 depicts an organization chart, in accordance with an illustrative embodiment.

FIG. 4 depicts flow diagram of a process for implementing smart directory searching, in accordance with an illustrative embodiment.

FIG. 5 depicts a workspace configured to provide smart directory searching for a set of workspace platforms, in accordance with an illustrative embodiment.

FIG. 6 depicts a network infrastructure, in accordance with an illustrative embodiment.

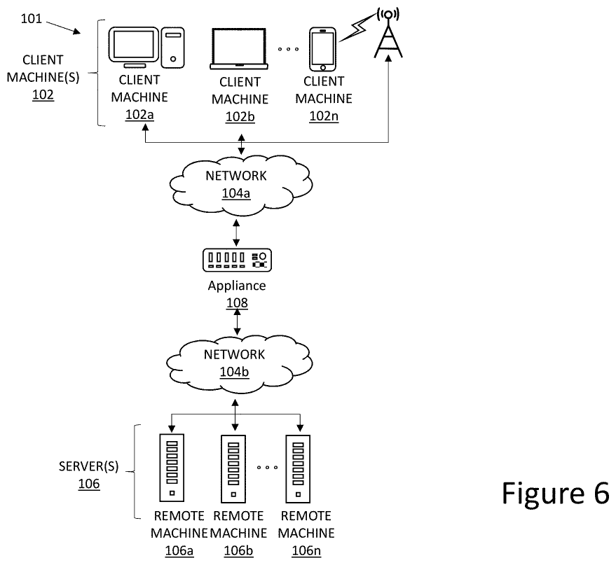

FIG. 7 depicts a computing system, in accordance with an illustrative embodiment.

FIG. 8A is a block diagram of an example system in which resource management services may manage and streamline access by clients to resource feeds (via one or more gateway services) and/or software-as-a-service (SaaS) applications.

FIG. 8B is a block diagram showing an example implementation of the system shown in FIG. 8A in which various resource management services as well as a gateway service are located within a cloud computing environment.

FIG. 8C is a block diagram similar to that shown in FIG. 8B but in which the available resources are represented by a single box labeled “systems of record,” and further in which several different services are included among the resource management services.

The drawings are intended to depict only typical aspects of the disclosure, and therefore should not be considered as limiting the scope of the disclosure.

### DETAILED DESCRIPTION OF THE DISCLOSURE

Embodiments of the disclosure provide technical solutions for providing smart directory searching for hosted and workspace-based collaboration platforms. For the purposes of this disclosure, the term “collaboration platform” (or simply “platform”) refers to any hosted application having a search directory that allows a user to enter a search string and obtain search results of other users or entities. As noted, when performing a directory search on such a platform, a list of search results are returned in response to an entered search string that consists of one or more typed characters. Each time a new character is added to the end of the string, the results are further filtered. However, because the results are often not in any specific order (other than alphabetical), the desired name may appear way down in the list of search results, requiring the searcher to type in more and more characters to narrow the search or scroll down through a large number of results.

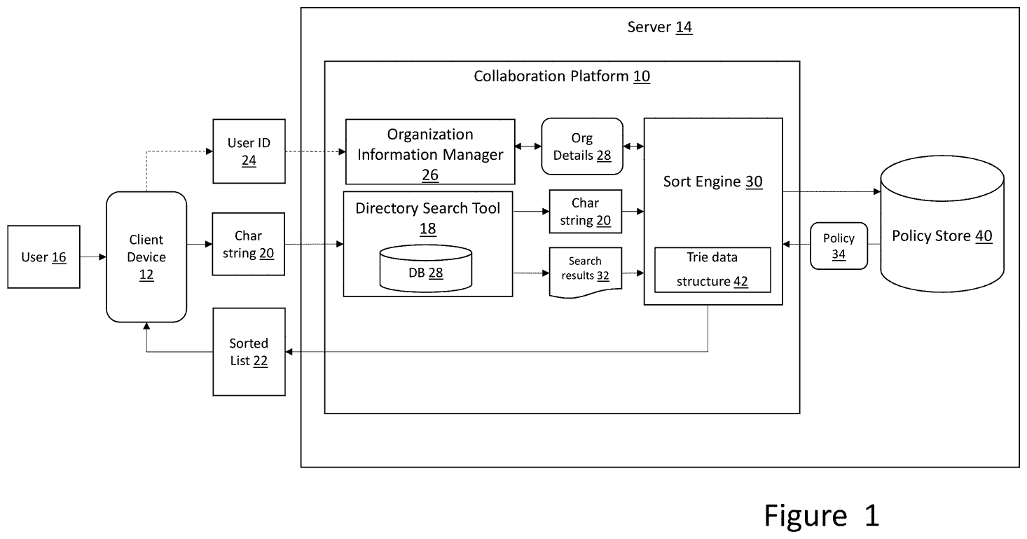

FIG. 1 depicts an illustrative collaboration platform 10 that provides smart directory searching, which runs on a server 14, accessible by a client device 12 for a user 16. Collaboration platform 10 includes a directory search tool 18 that allows the user 16 to submit a character string 20 and receive back a sorted list 22 of search results. Upon receiving a character string 20, the directory search tool 18 searches a user database (DB) 28 to generate a set of matching search results 32 that are unsorted (or only sorted, e.g., alphabetically).

The matching search results 32 are passed to a sort engine 30, which sorts the results 32 using organization details 28. Organization details 28 may for example be provided, generated or determined by an organization information manager 26 located within the collaboration platform 10 (as shown) or elsewhere, e.g., in a separate database, by a third party service, etc. Regardless, the organization details 28 may include, e.g., the name of the organization to which the user belongs (e.g., as determined by a user ID 24), the structure and details of names and resources within the organization (e.g., a hierarchical organization (org) chart, a user directory, information from a human resource database, a resource directory, etc.), the user's role in the organization (e.g., title, location, projects assigned, team, division, manager name, etc.), etc.

The sorted list 22 identifies the most relevant search results and e.g., places them at the top of the list. Accordingly, in the event the name sought by the user is identified as relevant and placed at the top of the list, the need to scroll down and/or type in additional characters is greatly reduced.

To perform the sort, sort engine 30 utilizes a sorting policy 34, which provides a set of rules for performing the sort on search results 32. A policy store 40 is implemented and stores different sorting policies available to sort engine 30 depending on the particular situation. In one illustrative embodiment, sort engine 30 retrieves the sorting policy 34 from policy store 40 based on an identity of an organization (from the organization details 28) and the particular platform 10 being utilized. Accordingly, the policy store 40 may hold policies for selectable platforms (e.g., Outlook, Jira, BitBucket, etc.) and selectable organizations (e.g., Company XYZ, Group ABC, Division A, etc.). An organization may take any form and may for example comprise an entire enterprise (e.g., a corporation), a division within an enterprise, a particular user group, a community, etc. Each stored sorting policy 34 provides a sort criteria that dictates how the search results 32 should be sorted by the sort engine 30 to generate the sorted list 22.

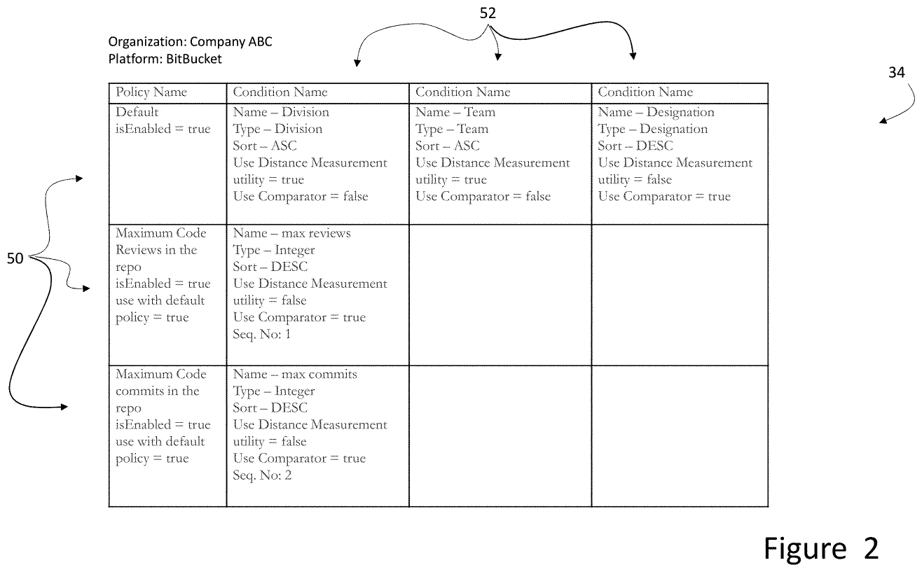

Sorting policies can be customized to meet the needs of particular organizations and platforms. FIG. 2 depicts an illustrative sorting policy 34 for a selected platform/organization, in this example the policy 34 is used to sort search results from BitBucket within Company ABC. In this example, the policy 34 is presented in the form of a table and includes a multilevel sort having three sub-policies 50 shown as rows in the table. In this case, sub-policies 50 are applied in sequential order from the top row of the table to the bottom row. Further, each sub-policy 50 may include one or more conditions 52, shown in the columns, which are applied as part of a given sub-policy.

Although shown as a table, it is understood that sorting policy 34 can be stored or provided in any form, e.g., an XML file, a script, a table, program code, etc. Regardless of the format of the sorting policy 34, policies can be customized for individual platforms and they can be chained with other policies for the same platform in a multilevel sort for optimized results. Policies that include multilevel sorts can specify an ordering of sub-policies, e.g., with a sequence number or the like, which represents the application order in a policy chain.

In one embodiment, each organization may include a default policy that will order the search results 32 based on the proximity or “organizational distance” between the user performing the search and each of the names in the search results 32. Examples of computing organizational distance are described below. In FIG. 2, the default policy is implemented in the top row of the table with the policy name “Default” (and is shown as enabled, “isEnable=true”). Within the default policy, three conditions are provided under the names: Division, Team, and Designation. Each condition sort results by calculating an organizational distance (i.e., Use Distance Measurement utility=true) or based on a simple match (i.e., Use Comparator=true). In this example, the first condition will calculate a distance between the user and other names based on divisions to which they belong, and order the results accordingly. Next, the second condition will calculate a distance between the user and other names based on the teams to which they belong. The third condition will identify returned names that have the same designation (e.g., job title) to again further order the results. Sorting for each condition can be ascending (ASC) or descending (DESC).

In this example, the default policy is chained with two custom sub-policies (rows two and three) which are enabled by setting the “use with default policy” flag to true. The second and third rows of the policy 34 shown in FIG. 2 specify that the results are to be further sorted based on the number of code reviews and number of code commits performed by the returned names. It is understood the type and number of policies described herein are for illustrative purposes, and other custom policies, sub-policies, conditions, etc., could be implemented.

In one embodiment, the sort engine 30 processes and stores the search results 22 and sorted list 22 in a prefix tree (“trie”) data structure 42 (FIG. 1). As new characters are entered by the user 16, the sorted list 22 is re-filtered with the help of the trie data structure 42 to provide relevant results more quickly. Trie data structures, which are widely understood in the field of computer science, are a type of search tree commonly used for processing character strings.

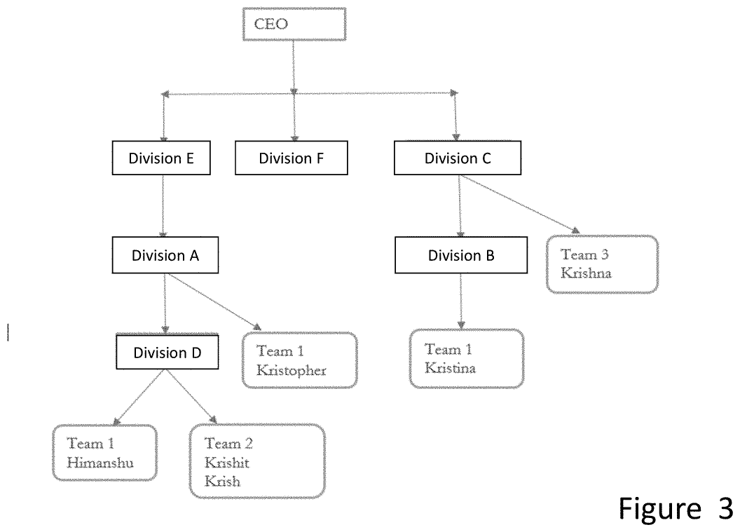

Computing the organizational distance between the user and search results 32 may be done in any manner. In one example, a hierarchical org tree such as that shown in FIG. 3 is utilized in which the organizational distance is computed by evaluating the number of nodes and/or edges between users in the org tree. Counting of nodes can for example be implemented with software routines, e.g., isContainedWithin(<T> obj1, <T> obj2) that determines if two objects (i.e., names) reside in the same node (e.g., division, team, etc.), and computeDistance(<T> obj1, <T> obj2) that determines a distance between two nodes. If isContainedWithin(<T> obj1, <T> obj2) returns a value “true”, the distance between objects will be considered as ‘0’ (e.g., indicating that the two names share the same division, increasing relevance for display at the beginning of the list). If it returns a value of false, then computeDistance( ) is used that returns an integer value. The closer the distance, the higher the value. isContainedWithin( ) and computeDistance( ) can for example be implemented by sort engine 30, which can import and use the org tree from the organization information manager 26. It is understood that any type of directed graph (graph) capable of storing entity information (e.g., user names, resources, etc.) in nodes could be utilized in determining an organizational distance (e.g., hierarchical, directed, symmetric, etc.).

In an example involving the org chart of FIG. 3, assume that a current user Himanshu, who works in Division D, Team 1 wants to perform a search for Krishit and enters the letter “K”. When ‘K’ is entered, a request is made to the DB 28 (FIG. 1) and all records starting with K for the current organization (ABC) are fetched and stored in the trie data structure 42. Additionally, organization details may also be included with the search results 32. The search results 32 may for example be as follows:

### Kristopher—Division A, Team 1, Director

### Kristina—Division B, Team 1, Manager

Krishna—Division C, Team 3, Sr. Software Engineer
Krish—Division D, Team 2, Software Engineer 2 (additional info includes: reviews 10, commits 3)
Krishit—Division D, Team 2, Software Engineer 2 (additional info includes—reviews 10, commits 9).

Using the policy 34 shown in FIG. 2 configured for BitBucket and organization ABC, the following execution sequence may be deployed for the above search results. First, the sort engine 34 fetches the sort policy 34 for the given organization and platform 10 from the policy store 40. As shown in the policy of FIG. 2, the default policy is enabled and there are two other custom sub-policies that are enabled as well and configured to be used along with default policy. The default policy conditions 52 first determines how relevant the list of the records in the search results are as compared to the current user's division, then by relevant teams, then by designation. In this case, the distance is computed based on the number of nodes between two entities. Distance results are generated as follows:

Distance between Division D and Division A=1
Distance between Division D and Division B=5
Distance between Division D and Division C=4
Distance between (Division D: Team 1) and (Division D: Team 2)=2
In one embodiment the above distances are computed using the routines computeDistance( ) and isContainedWithin( ). As noted, the organizational distance is computed as distance between nodes, which gives a measure of relevance between divisions, teams, etc. After applying default policies, Krish and Krishit appear at the beginning of the list followed by Kristopher, Krishna and Kristina (as determined based on their organizational distances). In this case, the application of default policy placed Krish before Krishit on the list (i.e., the fetch order regarding their division, team and designations are same). Next, application of subsequent sub-policies relating to code review and code commits are applied, and the first result that appears on the list is updated to Krishit (as he has the most commits). The following sorted list 22 would thus be output.

### Krishit

### Krish

### Kristopher

### Krishna

### Kristina

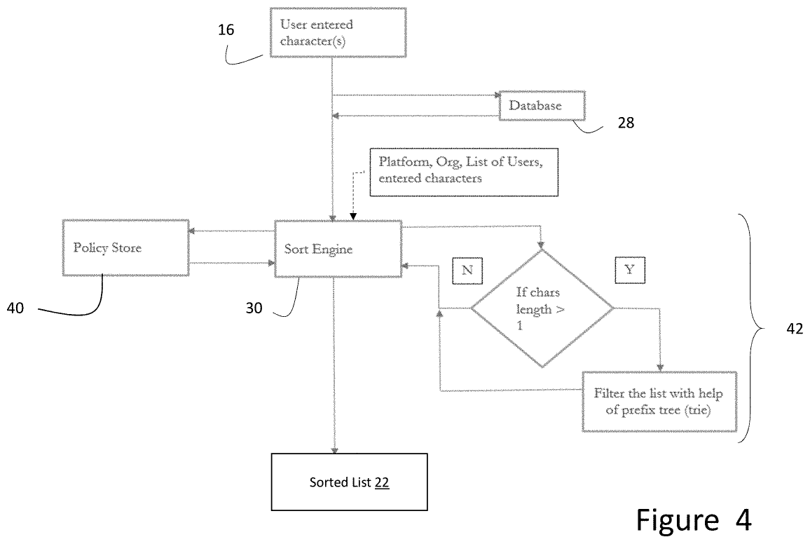

FIG. 4 depicts a flow diagram of an illustrative process of implementing smart directory searching with reference to FIG. 1. Initially, a user 16 enters one or more characters into a directory search tool 28. Database 28 fetches records based on the entered character string (initially a single character). The search results are forwarded to sort engine 30, which retrieves a sort policy based, e.g., on the platform and organization. If only one character is entered so far, the sort engine 30 sorts the search results, e.g., based on organizational distance, and outputs the sorted list. If more than one character is entered, then trie data structure 42 is utilized to facilitate filtering of the list 22.

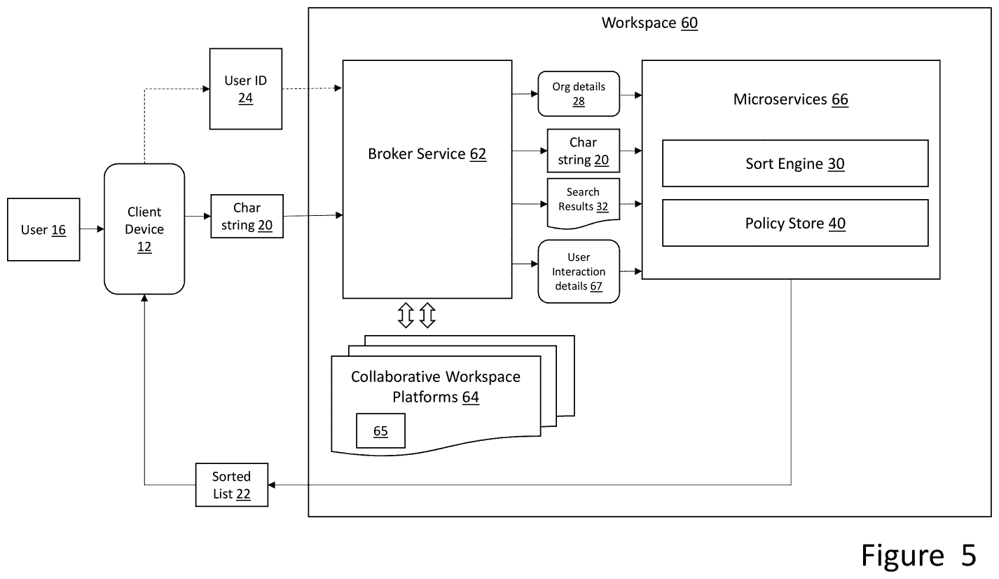

FIG. 5 depicts an alternative embodiment in which a workspace 60 is deployed with a set of internal collaborative workspace platforms 64 (or applications). In this example, a broker service 62 is provided that can intercept the directory calls to respective search directory tools 65 and determine which platform 64 was handling the request. For example, broker service 62 can determine that a directory search is being performed by Bitbucket for user 16. In addition, broker service can collect user interaction details 67 from all of the platforms 64 that can be used by the sort engine 30 as criteria for sorting search results 32. Interaction details 67 may include user profiles, user activities such as recorded counts of different types of inputs made by user with a platform. For example, broker service 62 can retrieve user information from any of the platforms that track numbers of commits, numbers of code reviews, etc., performed by individual users.

In the embodiment shown in FIG. 5, the sort engine 30 and policy store 40 are implemented as microservices 66 within the workspace 60. A combination of the sort engine 30 and policy store 40 can be considered as an abstract service layer that can be used with any platform 64. This approach avoids the need for third party services to implement sorting functionality.

Such an implementation can also be extended for providing generic searching (rather than just directory search). For example, a user within an organization could be searching for resources, such as printers, clients, white papers, videos, manuals, jobs, etc., within an organization and the sort engine 30/policy store 40 could be adapted to search based on organizational distance in the manner described herein.

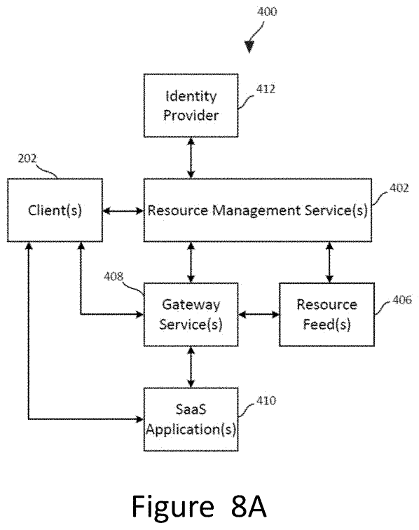

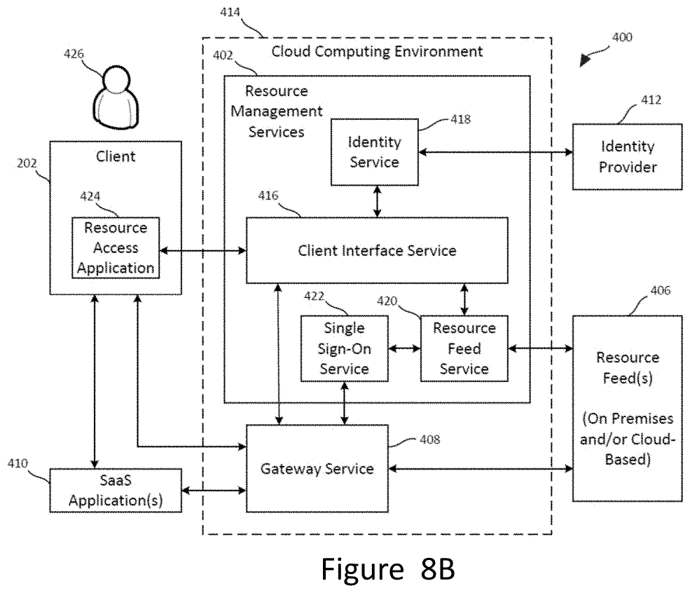

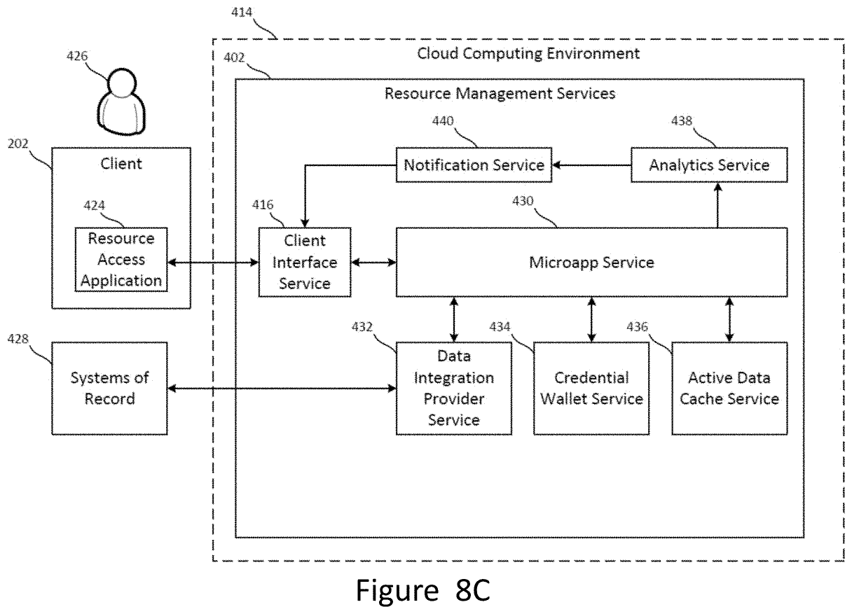

Referring to FIG. 8, a non-limiting network environment 101 in which various aspects of the disclosure may be implemented includes one or more client machines 102A-102N, one or more remote machines 106A-106N, one or more networks 104, 104′, and one or more appliances 108 installed within the computing environment 101. The client machines 102A-102N communicate with the remote machines 106A-106N via the networks 104, 104′.

In some embodiments, the client machines 102A-102N communicate with the remote machines 106A-106N via an intermediary appliance 108. The illustrated appliance 108 is positioned between the networks 104, 104′ and may also be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104 and/or 104′.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client device 102 may have the capacity to function as both a client node seeking access to resources provided by a server 106 and as a server 106 providing access to hosted resources for other client devices 102A-102N. The networks 104, 104′ may be generally referred to as a network 104. The networks 104 may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation services program or other program that uses a thin-client or a remote-display protocol to capture display output generated by an application executing on a server 106 and transmit the application display output to a client device 102.

In yet other embodiments, a server 106 may execute a virtual machine providing, to a user of a client device 102, access to a computing environment. The client device 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network 104; and a primary private network 104. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

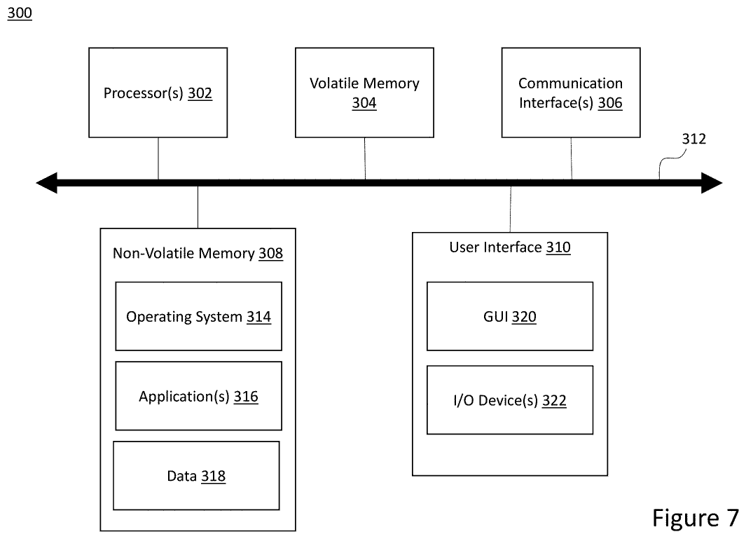

Elements of the described solution may be embodied in a computing system, such as that shown in FIG. 7 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 as shown in FIG. 7 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

FIG. 8A is a block diagram of an example system 400 in which one or more resource management services 402 may manage and streamline access by one or more clients 202 to one or more resource feeds 406 (via one or more gateway services 408) and/or one or more software-as-a-service (SaaS) applications 410. In particular, the resource management service(s) 402 may employ an identity provider 412 to authenticate the identity of a user of a client 202 and, following authentication, identify one of more resources the user is authorized to access. In response to the user selecting one of the identified resources, the resource management service(s) 402 may send appropriate access credentials to the requesting client 202, and the client 202 may then use those credentials to access the selected resource. For the resource feed(s) 406, the client 202 may use the supplied credentials to access the selected resource via a gateway service 408. For the SaaS application(s) 410, the client 202 may use the credentials to access the selected application directly.

The client(s) 202 may be any type of computing devices capable of accessing the resource feed(s) 406 and/or the SaaS application(s) 410, and may, for example, include a variety of desktop or laptop computers, smartphones, tablets, etc. The resource feed(s) 406 may include any of numerous resource types and may be provided from any of numerous locations. In some embodiments, for example, the resource feed(s) 406 may include one or more systems or services for providing virtual applications and/or desktops to the client(s) 202, one or more file repositories and/or file sharing systems, one or more secure browser services, one or more access control services for the SaaS applications 410, one or more management services for local applications on the client(s) 202, one or more internet enabled devices or sensors, etc. Each of the resource management service(s) 402, the resource feed(s) 406, the gateway service(s) 408, the SaaS application(s) 410, and the identity provider 412 may be located within an on-premises data center of an organization for which the system 400 is deployed, within one or more cloud computing environments, or elsewhere.

FIG. 8B is a block diagram showing an example implementation of the system 400 shown in FIG. 8A in which various resource management services 402 as well as a gateway service 408 are located within a cloud computing environment 414. The cloud computing environment may, for example, include Microsoft Azure Cloud, Amazon Web Services, Google Cloud, or IBM Cloud.

For any of illustrated components (other than the client 202) that are not based within the cloud computing environment 414, cloud connectors (not shown in FIG. 8B) may be used to interface those components with the cloud computing environment 414. Such cloud connectors may, for example, run on Windows Server instances hosted in resource locations and may create a reverse proxy to route traffic between the site(s) and the cloud computing environment 414. In the illustrated example, the cloud-based resource management services 402 include a client interface service 416, an identity service 418, a resource feed service 420, and a single sign-on service 422. As shown, in some embodiments, the client 202 may use a resource access application 424 to communicate with the client interface service 416 as well as to present a user interface on the client 202 that a user 426 can operate to access the resource feed(s) 406 and/or the SaaS application(s) 410. The resource access application 424 may either be installed on the client 202, or may be executed by the client interface service 416 (or elsewhere in the system 400) and accessed using a web browser (not shown in FIG. 8B) on the client 202.

As explained in more detail below, in some embodiments, the resource access application 424 and associated components may provide the user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 424 is launched or otherwise accessed by the user 426, the client interface service 416 may send a sign-on request to the identity service 418. In some embodiments, the identity provider 412 may be located on the premises of the organization for which the system 400 is deployed. The identity provider 412 may, for example, correspond to an on-premises Windows Active Directory. In such embodiments, the identity provider 412 may be connected to the cloud-based identity service 418 using a cloud connector (not shown in FIG. 8B), as described above. Upon receiving a sign-on request, the identity service 418 may cause the resource access application 424 (via the client interface service 416) to prompt the user 426 for the user's authentication credentials (e.g., user-name and password). Upon receiving the user's authentication credentials, the client interface service 416 may pass the credentials along to the identity service 418, and the identity service 418 may, in turn, forward them to the identity provider 412 for authentication, for example, by comparing them against an Active Directory domain. Once the identity service 418 receives confirmation from the identity provider 412 that the user's identity has been properly authenticated, the client interface service 416 may send a request to the resource feed service 420 for a list of subscribed resources for the user 426.

In other embodiments (not illustrated in FIG. 8B), the identity provider 412 may be a cloud-based identity service, such as a Microsoft Azure Active Directory. In such embodiments, upon receiving a sign-on request from the client interface service 416, the identity service 418 may, via the client interface service 416, cause the client 202 to be redirected to the cloud-based identity service to complete an authentication process. The cloud-based identity service may then cause the client 202 to prompt the user 426 to enter the user's authentication credentials. Upon determining the user's identity has been properly authenticated, the cloud-based identity service may send a message to the resource access application 424 indicating the authentication attempt was successful, and the resource access application 424 may then inform the client interface service 416 of the successfully authentication. Once the identity service 418 receives confirmation from the client interface service 416 that the user's identity has been properly authenticated, the client interface service 416 may send a request to the resource feed service 420 for a list of subscribed resources for the user 426.

For each configured resource feed, the resource feed service 420 may request an identity token from the single sign-on service 422. The resource feed service 420 may then pass the feed-specific identity tokens it receives to the points of authentication for the respective resource feeds 406. Each resource feed 406 may then respond with a list of resources configured for the respective identity. The resource feed service 420 may then aggregate all items from the different feeds and forward them to the client interface service 416, which may cause the resource access application 424 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 410 to which the user 426 has subscribed. The lists of local applications and the SaaS applications 410 may, for example, be supplied by resource feeds 406 for respective services that manage which such applications are to be made available to the user 426 via the resource access application 424. Examples of SaaS applications 410 that may be managed and accessed as described herein include Microsoft Office 365 applications, SAP SaaS applications, Workday applications, etc.

For resources other than local applications and the SaaS application(s) 410, upon the user 426 selecting one of the listed available resources, the resource access application 424 may cause the client interface service 416 to forward a request for the specified resource to the resource feed service 420. In response to receiving such a request, the resource feed service 420 may request an identity token for the corresponding feed from the single sign-on service 422. The resource feed service 420 may then pass the identity token received from the single sign-on service 422 to the client interface service 416 where a launch ticket for the resource may be generated and sent to the resource access application 424. Upon receiving the launch ticket, the resource access application 424 may initiate a secure session to the gateway service 408 and present the launch ticket. When the gateway service 408 is presented with the launch ticket, it may initiate a secure session to the appropriate resource feed and present the identity token to that feed to seamlessly authenticate the user 426. Once the session initializes, the client 202 may proceed to access the selected resource.

When the user 426 selects a local application, the resource access application 424 may cause the selected local application to launch on the client 202. When the user 426 selects a SaaS application 410, the resource access application 424 may cause the client interface service 416 request a one-time uniform resource locator (URL) from the gateway service 408 as well a preferred browser for use in accessing the SaaS application 410. After the gateway service 408 returns the one-time URL and identifies the preferred browser, the client interface service 416 may pass that information along to the resource access application 424. The client 202 may then launch the identified browser and initiate a connection to the gateway service 408. The gateway service 408 may then request an assertion from the single sign-on service 422. Upon receiving the assertion, the gateway service 408 may cause the identified browser on the client 202 to be redirected to the logon page for identified SaaS application 410 and present the assertion. The SaaS may then contact the gateway service 408 to validate the assertion and authenticate the user 426. Once the user has been authenticated, communication may occur directly between the identified browser and the selected SaaS application 410, thus allowing the user 426 to use the client 202 to access the selected SaaS application 410.

In some embodiments, the preferred browser identified by the gateway service 408 may be a specialized browser embedded in the resource access application 424 (when the resource application is installed on the client 202) or provided by one of the resource feeds 406 (when the resource application 424 is located remotely), e.g., via a secure browser service. In such embodiments, the SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have the client interface service 416 send the link to a secure browser service, which may start a new virtual browser session with the client 202, and thus allow the user to access the potentially harmful linked content in a safe environment.

In some embodiments, in addition to or in lieu of providing the user 426 with a list of resources that are available to be accessed individually, as described above, the user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 426 of something that requires the user's attention (e.g., approval of an expense report, new course available for registration, etc.).

FIG. 8C is a block diagram similar to that shown in FIG. 8B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 8C may enable the provision of a streamlined resource activity feed and/or notification process for a client 202. In the example shown, in addition to the client interface service 416 discussed above, the illustrated services include a microapp service (or simply “microservice”) 430, a data integration provider service 432, a credential wallet service 434, an active data cache service 436, an analytics service 438, and a notification service 440. In various embodiments, the services shown in FIG. 8C may be employed either in addition to or instead of the different services shown in FIG. 8B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 424 without having to launch the native application. The system shown in FIG. 8C may, for example, aggregate relevant notifications, tasks, and insights, and thereby give the user 426 a dynamic productivity tool. In some embodiments, the resource activity feed may be intelligently populated by utilizing machine learning and artificial intelligence (AI) algorithms. Further, in some implementations, microapps may be configured within the cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 8C, the systems of record 428 may represent the applications and/or other resources the resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 402, and in particular the data integration provider service 432, may, for example, support REST API, JSON, OData-JSON, and 6ML. As explained in more detail below, the data integration provider service 432 may also write back to the systems of record, for example, using OAuth2 or a service account.

In some embodiments, the microapp service 430 may be a single-tenant service responsible for creating the microapps. The microapp service 430 may send raw events, pulled from the systems of record 428, to the analytics service 438 for processing. The microapp service may, for example, periodically pull active data from the systems of record 428.

In some embodiments, the active data cache service 436 may be single-tenant and may store all configuration information and microapp data. It may, for example, utilize a per-tenant database encryption key and per-tenant database credentials.

In some embodiments, the credential wallet service 434 may store encrypted service credentials for the systems of record 428 and user OAuth2 tokens.

In some embodiments, the data integration provider service 432 may interact with the systems of record 428 to decrypt end-user credentials and write back actions to the systems of record 428 under the identity of the end-user. The write-back actions may, for example, utilize a user's actual account to ensure all actions performed are compliant with data policies of the application or other resource being interacted with.

In some embodiments, the analytics service 438 may process the raw events received from the microapps service 430 to create targeted scored notifications and send such notifications to the notification service 440.

Finally, in some embodiments, the notification service 440 may process any notifications it receives from the analytics service 438. In some implementations, the notification service 440 may store the notifications in a database to be later served in a notification feed. In other embodiments, the notification service 440 may additionally or alternatively send the notifications out immediately to the client 202 as a push notification to the user 426.

In some embodiments, a process for synchronizing with the systems of record 428 and generating notifications may operate as follows. The microapp service 430 may retrieve encrypted service account credentials for the systems of record 428 from the credential wallet service 434 and request a sync with the data integration provider service 432. The data integration provider service 432 may then decrypt the service account credentials and use those credentials to retrieve data from the systems of record 428. The data integration provider service 432 may then stream the retrieved data to the microapp service 430. The microapp service 430 may store the received systems of record data in the active data cache service 436 and also send raw events to the analytics service 438. The analytics service 438 may create targeted scored notifications and send such notifications to the notification service 440. The notification service 440 may store the notifications in a database to be later served in a notification feed and/or may send the notifications out immediately to the client 202 as a push notification to the user 426.

In some embodiments, a process for processing a user-initiated action via a microapp may operate as follows. The client 202 may receive data from the microapp service 430 (via the client interface service 416) to render information corresponding to the microapp. The microapp service 430 may receive data from the active data cache service 436 to support that rendering. The user 426 may invoke an action from the microapp, causing the resource access application 424 to send that action to the microapp service 430 (via the client interface service 416). The microapp service 430 may then retrieve from the credential wallet service 434 an encrypted Oauth2 token for the system of record for which the action is to be invoked, and may send the action to the data integration provider service 432 together with the encrypted Oath2 token. The data integration provider service 432 may then decrypt the Oath2 token and write the action to the appropriate system of record under the identity of the user 426. The data integration provider service 432 may then read back changed data from the written-to system of record and send that changed data to the microapp service 430. The microapp service 432 may then update the active data cache service 436 with the updated data and cause a message to be sent to the resource access application 424 (via the client interface service 416) notifying the user 426 that the action was successfully completed.

In some embodiments, in addition to or in lieu of the functionality described above, the resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 402 may, for example, parse these requests and respond because they are integrated with multiple systems on the back-end. In some embodiments, users may be able to interact with the virtual assistance through either the resource access application 424 or directly from another resource, such as Microsoft Teams. This feature may allow employees to work efficiently, stay organized, and deliver only the specific information they're looking for.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

1. A system, comprising:
a memory; and
a processor coupled to the memory and configured to implement a collaborative platform having a search facility that returns a set of search results in response to at least one character entered by a user, wherein the collaborative platform further includes a sort engine that sorts the set of search results according to method that includes:
inputting the set of search results and organization details of the user that include an organization to which the user belongs;
obtaining a policy from a policy store based on the organization and the collaborative platform, wherein the policy specifies a sort criteria; and
applying the sort criteria to the search results to generate a sorted list of search results, wherein the sort criteria includes calculating an organizational distance between the user and each of the search results.

2. The system of claim 1, wherein the collaborative platform includes one of a personal information manager, an email application, a calendar application, a collaboration service, and a project management service.

3. The system of claim 1, wherein the organizational distance is calculated based on an organization tree.

4. The system of claim 3, wherein the organizational distance between the user and a selected search result is calculated based on a number of nodes between a first node to which the user belongs and a second node to which the selected search result belongs within the organizational tree.

5. The system of claim 1, wherein the sort criteria includes a set of sequenced sub-policies and the sort engine performs a multilevel sort based on the sequenced sub-policies, wherein the multilevel sort is performed by the sort engine by applying the sequenced sub-policies in sequential order.

6. The system of claim 1, wherein the sort engines stores the set of search results in a prefix tree data structure.

7. The system of claim 6, wherein the prefix tree data structure filters the set of search results in response to the user entering a further character in the search facility

8. A method for sorting a set of user names generated by a search facility within a platform generated in response to at least one character entered by a user, comprising:
inputting into a sort engine the set of user names and organization details of the user that includes an organization to which the user belongs;
obtaining a policy from a policy store based on the organization and the platform, wherein the policy specifies a sort criteria; and
applying the sort criteria to the set of user names to generate a sorted list of user names, wherein the sort criteria includes calculating an organizational distance between the user and each of the set of user names.

9. The method of claim 8, wherein the platform includes one of a personal information manager, an email application, a calendar application, a collaboration service, and a project management service.

10. The method of claim 8, wherein the organizational distance is calculated based on an organization tree.

11. The method of claim 10, wherein the organizational distance between the user and a selected user name is calculated based on a number of nodes between a first node to which the user belongs and a second node to which the selected user name belongs within the organizational tree.

12. The method of claim 8, wherein the sort criteria includes a set of sequenced sub-policies and the sort engine performs a multilevel sort based on the sequenced sub-policies, wherein the multilevel sort is performed by the sort engine by applying the sequenced sub-policies in sequential order.

13. The method of claim 8, wherein the sort engines stores the set of user names in a prefix tree data structure.

14. The method of claim 13, wherein the prefix tree data structure filters the set of user names in response to the user entering a further character in the search facility.

15. A system, comprising:
a memory;
a processor coupled to the memory and configured to implement a virtual workspace comprising:
a plurality of workspace applications, each having a search facility that performs a search in response to at least one character entered by a user;
a brokering service configured to perform a method that includes:
intercepting calls to a search facility within an active application;
obtaining a set of search results from the search facility; and
determining interaction details of the user with the active application; and
a first microservice that sorts the set of search results according to method that includes:
inputting the search results, an organization to which the user belongs, and the interaction details of the user;
obtaining a policy from a second microservice based on the organization and active application, wherein the policy specifies a sort criteria; and
applying the sort criteria to the search results to generate a sorted list of search results, wherein the sort criteria includes analyzing the interaction details to calculate a distance between the user and each of the search results.

16. The system of claim 15, wherein the active application includes one of a personal information manager, an email application, a calendar application, a collaboration service, and a project management service.

17. The system of claim 15, wherein the distance is calculated using a graph.

18. The system of claim 17, wherein the distance between the user and a selected search result is calculated based on a number of interactions from the interaction details between a first node to which the user belongs and a second node to which the selected search result is associated within the graph.

19. The system of claim 15, wherein the interaction details include a user profile from the active application.

20. The system of claim 15, wherein the interaction details include counts of different types of inputs made by the user with the active application.
